(19) United States
(12) Patent Application Publication
(10) Pub. No.: US 2020/0278101 A1
(43) Pub. Date: Sep. 3, 2020

(54) LENS, LIGHTING DEVICE, LUMINAIRE AND APPARATUS

(71) Applicant: PHILIPS LIGHTING HOLDING B.V., EINDHOVEN (NL)

(72) Inventor: Dany Dy TANG, EINDHOVEN (NL)

(21) Appl. No.: 16/068,049

(22) PCT Filed: Dec. 19, 2016
(86) PCT No.: PCT/EP2016/081745

§ 371 Date: Jul. 3, 2018

(30) Foreign Application Priority Data
Jan. 5, 2016 (CN) PCT/CN2016/070163
Feb. 1, 2016 (EP) 16153678.4

(51) Int. Cl. F21V 5/04; G02B 3/00

(52) U.S. Cl. CPC F21V 5/043; F21Y 2103/10; G02B 3/00

(57) ABSTRACT

Disclosed is a lens (10) which is an integrated single piece, comprising an inner arch (20) and an outer arch (30), the inner arch and outer arch having a shared elongate central region (13) and each having opposing walls (21, 31) extending from opposite elongate ends of the shared elongate central region, wherein the walls (21) of the inner arch are spatially separated from the walls (31) of the outer arch. A lighting device comprising such a lens, a luminaire comprising such a lighting device and an apparatus comprising such a luminaire or lighting device are also disclosed.

### FIELD OF THE INVENTION

The present invention relates to a lens having an elongate arch shape.

The present invention further relates to a lighting device comprising such a lens.

The present invention yet further relates to a luminaire comprising such a lighting device.

The present invention yet further relates to an apparatus comprising such a luminaire or lighting device.

### BACKGROUND OF THE INVENTION

Solid state lighting such as LED lighting is rapidly gaining popularity due to the green credentials of such lighting. Typically, solid state lighting devices produce their luminous outputs at a fraction of the energy consumption of incandescent or halogen lighting devices. In addition, solid state lighting devices have superior lifetimes compared to incandescent and halogen lighting devices.

In order to generate a luminous output of sufficient intensity, a solid state lighting device typically comprises a plurality of solid state lighting elements, which may be arranged in a regular pattern in other to obtain a homogeneous luminous output. For example, the solid state lighting device may be provided as strip lighting in which a plurality of solid state lighting elements, e.g. LEDs, are mounted on an elongate, e.g. a rectangular, strip such as a printed circuit board strip.

Solid state lighting elements such as LEDs typically produce a Lambertian luminous distribution, which is notably different to the more uniform luminous distribution produced by more traditional lighting devices such as incandescent or halogen lighting devices. This may be undesirable for aesthetic reasons as well as for practical reasons because a lighting device comprising such solid state lighting elements may produce a luminous distribution that is suboptimal within a particular application domain. For this reason, lighting devices based on solid state lighting devices including solid state lighting elements often comprise one or optical elements such as lenses, collimators and/or diffusers in order to manipulate the luminous distribution produced by the solid state lighting device, for example to make it more similar to the luminous distribution produced by traditional lighting devices such as incandescent or halogen lighting devices.

WO 2015/043468 A1 discloses an arch-shaped lens having an elongate arch for shaping the luminous distribution produced with an elongate lighting strip carrying a plurality of LEDs. In order to achieve the desired lens effect, the thickness of the walls of the elongate arch needs to be varied, with a larger variation required for a stronger lens effect. However, such large variations in thickness make the manufacturing process of such a lens particulate cumbersome and costly, for example because the provision of the tooling to manufacture the lens is far from straightforward. Moreover, the un-balanced shrinkage of such variable thickness walls during manufacture can cause many product failures, thus undesirably lowering the yield of the manufacturing process.

### SUMMARY OF THE INVENTION

The present invention seeks to provide an elongate lens that can provide a desired lens effect and can be manufactured in a more cost effective-manner.

The present invention further seeks to provide a lighting device comprising such a lens.

The present invention yet further seeks to provide a luminaire comprising such a lighting device.

The present invention still further seeks to provide an apparatus comprising such a luminaire or lighting device.

According to an aspect, there is provided a lens which is an integrated single piece, comprising an inner arch and an outer arch, the inner arch and outer arch having a shared elongate central region and each having opposing walls extending from opposite elongate ends of the shared elongate central region, wherein the walls of the inner arch are spatially separated from the walls of the outer arch.

In the lens according to embodiments of the present invention, the lens effect is achieved by multiple adjacent elongate arches that combine to provide the desired lens effect. Consequently, only a modest thickness variation is required across the walls of a single arch, thus significantly simplifying the required tooling and manufacturing process of such a lens, such that such a lens may be manufactured in a cost-effective manner e.g. by improving the yield of the manufacturing process.

The lens may be made of an optical grade polymer or blend of such polymers. This has the advantage that the lens may be made in a particularly cost-effective manner, e.g. using extrusion, moulding or casting techniques.

The optical grade polymer or polymer blend may for instance be selected from one or more of polyethylene terephthalate (PET), poly (methyl methacrylate) (PMMA) and polycarbonate (PC) as these polymers are known to exhibit excellent optical characteristics and are easily extruded, moulded or cast into a desired three-dimensional shape. Of these optical grade polymers, polycarbonate is particularly preferred.

The respective walls of the inner arch and/or the respective walls of the outer arch may have a thickness that varies by less than 20%, e.g. by less than 10% to yield a lens that can be manufactured in a particularly cost-effective manner in a high yield.

The respective walls of the inner arch and/or the respective walls of the outer arch may have a thickness that increases in a direction away from the shared elongate central region in order to achieve the desired lens effect.

The lens according to embodiments of the present invention is not limited to having an inner arch and an outer arch only. In some embodiments, the lens may further comprise at least one intermediate arch in between the inner arch and the outer arch, the at least one intermediate arch including the shared elongate central region and having a pair of walls extending from opposite elongate ends of the shared central region, the walls of the at least one intermediate arch being spatially separated from and located in between the respective walls of the inner arch and outer arch. In this manner, the thickness variation required in the walls of the individual arches to achieve the desired lens effect may be even further reduced.

An outer surface of the outer arch may be semi-cylindrical in order to facilitate positioning of the lens on a carrier substrate. Further, the inner arch and the outer arch have a curved cross-sections and are both bent in a same direction.

According to another aspect, there is provided a lighting device comprising a substrate carrying the lens of any of the above embodiments such that at least two of the walls of the respective arches of the lens are placed on the substrate, the substrate further carrying at least one solid state lighting device positioned within a cavity delimited by the inner arch of the lens, the at least one solid state lighting device being arranged to direct its luminous output towards the inner arch. Such a lighting device may be produced at a lower cost due to the relatively straightforward manufacturing process of the lens according to embodiments of the present invention.

The at least one solid state lighting device may comprise a plurality of solid state lighting elements at regular intervals within the cavity in order to increase the luminous output intensity o f the lighting device.

The solid state lighting elements may share a carrier such as a lighting strip or PCB, said carrier being mounted on the substrate. The lighting device according to this embodiment may be manufactured in a particularly cost-effective manner due to the fact that the respective solid state lighting elements do not require individual positioning on the substrate.

The at least one solid state lighting device may be a LED. Where a plurality of solid state lighting devices is present in the lighting device, the LEDs may be identical or may be different LEDs, e.g. LEDs capable of producing respective luminous outputs with different spectral compositions, e.g. white light with different colour temperatures or different coloured light, which different LEDs may be individually controllable to provide a lighting device in which the spectral composition of its luminous output may be configured by controlling different individual LEDs.

The lighting device may be a light bulb such as a tubular light bulb although embodiments of the lighting device are not limited thereto.

According to yet another aspect, there is provided a luminaire comprising the lighting device of any of claims. Such a luminaire for example may be a ceiling-mountable luminaire, e.g. a troffer or the like, a road or street lighting luminaire for mounting on a pole, a stand-alone luminaire such as a desk lamp, although embodiments of the luminaire are not limited thereto.

According to still another aspect, there is provided an apparatus comprising the lighting device or the luminaire according to any of the above embodiments. Such an apparatus for example may be an electrical device comprising integrated illumination, e.g. a fridge, freezer, microwave, extractor, and so on although embodiments of the apparatus are not limited thereto.

### BRIEF DESCRIPTION OF THE DRAWINGS

Embodiments of the invention are described in more detail and by way of non-limiting examples with reference to the accompanying drawings, wherein:

FIG. 1 schematically depicts a perspective view of an elongate lens according to an embodiment;

FIG. 2 schematically depicts a cross-sectional view of an elongate lens according to another embodiment;

FIG. 3 schematically depicts a cross-sectional view of a lighting device according to an embodiment;

FIG. 4 schematically depicts a cross-sectional view of a luminous distribution produced by a lighting device according to an embodiment;

FIG. 5 schematically depicts a front view of a luminous distribution produced by a lighting device according to an embodiment; and

FIG. 6 schematically depicts a polar plot of a luminous distribution produced by a lighting device according to an embodiment.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

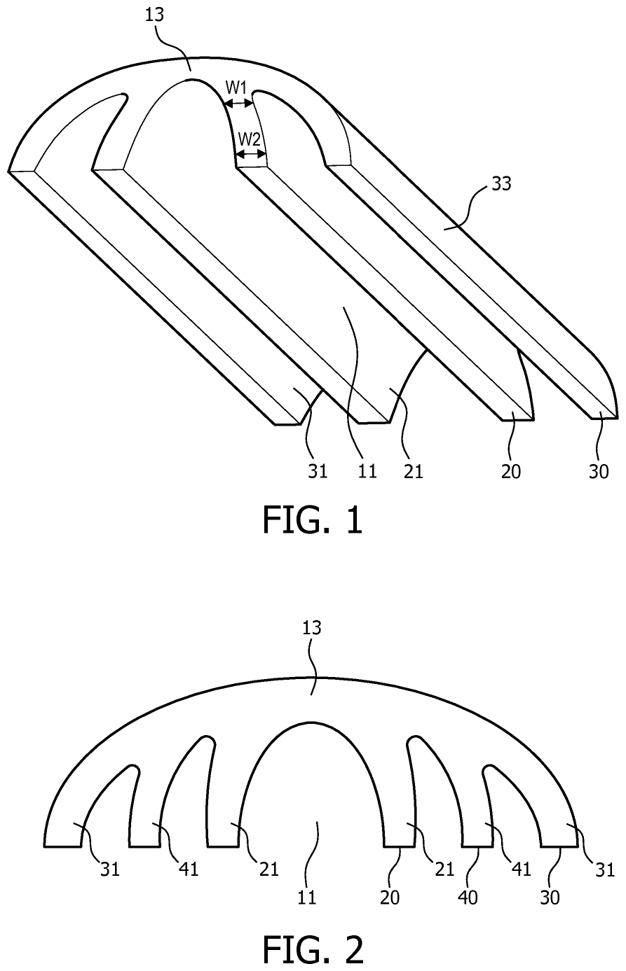

FIG. 1 schematically depicts a perspective view of an elongate lens 10 according to an embodiment. The elongate lens 10 according to embodiments of the present invention comprises a plurality of elongate arches including an inner arch 20 and an outer arch 30 that share an elongate central region 13 from which the respective opposing walls of the elongate arches emanate, such as the opposing walls 21 of the inner arch 20 and the opposing walls 31 of the outer arch 30, with the opposing walls of respective elongate arches being spatially separated from each other. In the context of the present application, the term ‘elongate’ is used to specify a structure that extends in different amounts in two perpendicular directions. For example, where reference is made to the elongate central region 13, this means that the central regions 13 extends further in a length direction than it does in a width direction. Similarly, respective arches of the elongate lens 10 extend further in the length direction than in the width direction.

The respective arches of the elongate lens 10 combine to provide the optical function of the elongate lens 10. That is, the elongate lens 10 may be positioned on a carrier carrying one or more light sources such that the one or more light sources are positioned under the inner arch 20, i.e. within a cavity 11 delimited by the inner arch 20, with at least a fraction of the light generated by the one or more light sources passing through a wall 21 of the inner arch 20, the air gap between the wall 21 of the inner arch 20 and an opposing wall 31 of the outer arch 30, and the opposing wall 31 of the outer arch 30 before exiting the elongate lens 10 through an outer surface 33 of the elongate lens 10. Consequently, whereas the walls of the elongate lens 10 through which this fraction of the light travels have a combined thickness variation, e.g. a thickness increasing from a wall portion proximal to the central region 13 to a further wall portion distal to the central region 13, e.g. an end portion or foot of an arch, the individual walls of the respective arches of the elongate lens 10 may have a reduced thickness variation compared to an elongate lens comprising a single arch only, such as the lens disclosed in WO 2015/043468 A1, which means that the elongate lens 10 according to embodiments of the present invention may be manufactured more easily due to the fact that tooling to produce the more modest thickness variations in the opposing walls of the respective arches of the elongate lens 10 may be more straightforwardly provided. The more modest thickness variations in the opposing walls of the respective arches of the elongate lens 10 may further significantly reduce the risk of product failures during manufacture, thereby improving the yield of the manufacturing process due to the fact that the lens failures caused by material shrinkage effects will be significantly reduced.

Moreover, due to the fact that the elongate lens 10 according to embodiments of the present invention employs an optical function based on a plurality of arch walls separated by air gaps, such an elongate lens requires less optical material and is therefore more lightweight than the prior art elongate lens 10 disclosed in WO 2015/043468 A1.

In an embodiment, a wall portion proximal to the central region 13 may define a minimum thickness W1 of an arch wall, e.g. an inner arch wall 21 and/or an outer arch wall 31, and a further wall portion distal to the central region 13 may define a maximum thickness W2 this arch wall, wherein a maximum thickness W2 varies by less than 20% from the minimum thickness W1. The maximum thickness W2 may vary by less than 10% from the minimum thickness W1.

However, depending on the optical function required, the distal wall portion of an arch wall may be thicker than the proximal wall portion of the arch wall. For example, a wall portion proximal to the central region 13 may define a maximum thickness W1 of an arch wall, e.g. an inner arch wall 21 and/or an outer arch wall 31, and a further wall portion distal to the central region 13 may define a minimum thickness W2 of this arch wall, wherein a maximum thickness W1 varies by less than 20% from the minimum thickness W2. The maximum thickness W1 may vary by less than 10% from the minimum thickness W2. It should be understood that other thickness variations in the respective wall portions of the arches of the elongate lens 10 may be contemplated.

The elongate lens 10 may be manufactured of any suitable optical material, e.g. a substantially transparent material having a refractive index different to air. For example, the elongate lens 10 may be manufactured from a type of glass or an optical grade polymer such as PET, PMMA or PC. An optical grade polymer is particularly mentioned as such materials may be easily moulded into a desired shape, e.g. through extrusion, mold casting or similar techniques, thereby providing an elongate lens 10 in a particularly cost-effective manner. PC is a particularly preferred optical grade polymer due to its low cost and excellent mechanical properties, e.g. hardness and scratch-resistance.

The elongate lens 10 according to embodiments of the present invention may comprise a semi-cylindrical outer surface 31, that is, the overall shape of the elongate lens 10 may be semi-cylindrical. In the context of the present application, a semi-cylindrical shape is not intended to be limited to a shape having a semi-circular cross-section only; it should be understood that other curved cross-sections are equally feasible, e.g. semi-ellipsoid cross-sections, parabolic cross-sections, and so on.

In FIG. 1, the elongate lens 10 comprises a pair of arches including an inner arch 20 and an outer arch 30 having a shared central region 13 as explained above. However, it should be understood that the number of arches having a shared central region 13 and opposing walls emanating from the central region 13 and being spatially separated from each other and from the opposing walls of neighboring arches may be increased without departing from the teachings of the present invention. For example, FIG. 2 schematically depicts a cross-section of an elongate lens 10 according to an embodiment in which the elongate lens 10 comprises an intermediate arch 40 in between the inner arch 20 and the outer arch 30, with the intermediate arch 40 comprising opposing elongate walls 41 that are spatially separated from each other, with each elongate wall 41 being positioned in between and spatially separated from an elongate wall 21 of the inner arch 20 and an elongate wall 31 of the outer arch 30. In this manner, the elongate lens 10 may comprise any suitable number of intermediate arches 40 in between the inner arch 20 and the outer arch 30 that are spatially separated from each other and from the inner arch 20 and outer arch 30 as explained above. As before, the inner arch 20 delimits a cavity 11 in which one or more illumination sources or light engines may be placed.

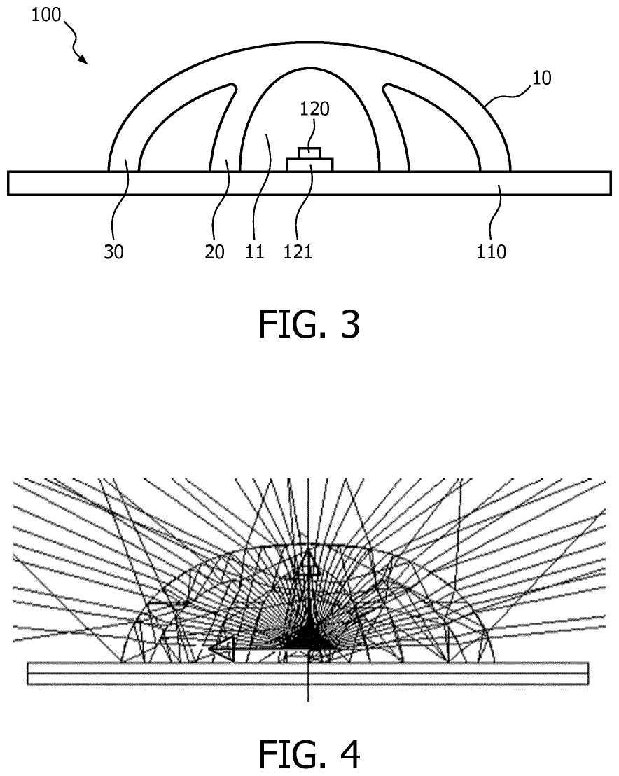

FIG. 3 schematically depicts a lighting device 100 comprising an elongate lens 10 according to an embodiment of the present invention, a substrate 110 onto which the elongate lens 10 is placed and at least one solid state lighting (SSL) device 120 positioned within the cavity 11 delimited by the inner arch 20 of the elongate lens 10 and a portion of the substrate 110. The at least one SSL device 120 is arranged within the cavity 11 such that it directs its luminous output towards the inner arch 20. The at least one SSL device 120 may be directly positioned onto the substrate 110 or may be positioned on a carrier 121, which carrier 121 is positioned onto the substrate 110. Each SSL device 120 may be a LED or may comprise one or more LEDs. In a preferred embodiment, the at least one SSL device 120 comprises a plurality of SSL devices 120 positioned in the elongate direction at regular intervals within the cavity 11. The plurality of SSL devices 120 may be directly positioned onto the substrate 110 or may share a carrier 121 such as a PCB, which carrier 121 is positioned onto the substrate 110.

In an embodiment, at least a part of the substrate 110 may be made of a thermally conductive material, such as a metal or metal alloy, with the at least one SSL device 120 being thermally coupled to the thermally conductive material, such that the thermally conductive material may act as a heatsink for the at least one SSL device 120. The thermally conductive material may be protected by an electrically insulating material to prevent a user of the lighting device 100 from accidental electric shock. For example, the lighting device 100 may comprise an electrically insulating housing (not shown) in which the elongate lens 10 the substrate 110 and the at least one SSL device 120 are positioned. The elongate lens 10 may define a part of this housing.

In an alternative embodiment, the substrate 110 may be made of an electrically insulating material, in which case the housing of the lighting device 100 may at least in part be defined by the substrate 110 and the elongate lens 10. In this embodiment, the at least one SSL device 120 may be placed on a carrier 121 further acting as a heatsink of the at least one SSL device 120. It should be understood that these are mere examples of housing arrangements of the lighting device 100, and that any suitable housing arrangement may be contemplated.

In an embodiment, the lighting device 100 defines a strip-shaped lighting device having a plurality of SSL devices 120 arranged at regular intervals within the cavity 11 as previously explained. The lighting device 100 may further include a controller (not shown) for controlling the SSL devices 120 such as a driver or the like. The controller may be adapted to simultaneously control the individual SSL devices 120 with a single (overall) control signal or alternatively may be adapted to individually control the individual SSL devices 120 with respective individual control signals. The latter embodiment for example may be advantageous to create lighting effects with the lighting device 100, e.g. different light patterns by engaging different SSL devices 120 at different points in time. In an embodiment, the lighting device 100 may include different white light or coloured light-producing SSL devices 120, in which the individual control of such SSL devices may be invoked to produce a luminous output of a particular spectral composition, e.g. a particular colour temperature or colour, with the lighting device 100.

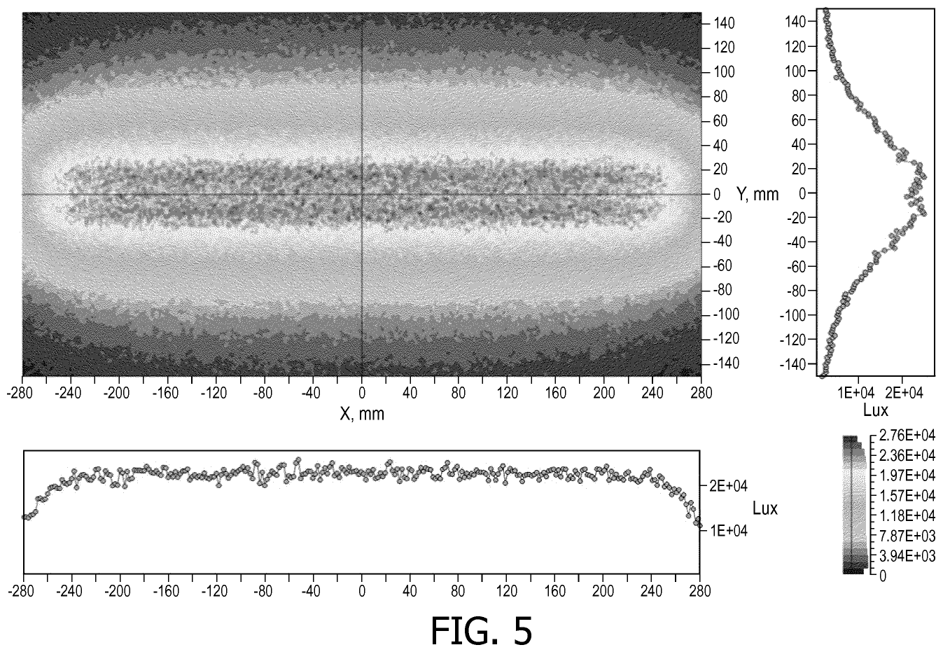

FIG. 4 schematically depicts a cross-sectional view of a luminous distribution produced by an elongate lighting device 100 according to an embodiment and FIG. 5 schematically depicts a front view of this luminous distribution. These luminous distributions demonstrate that a substantially homogeneous illumination in the elongation direction of the elongate lens 10 may be produced by such a lighting device 100, thereby demonstrating that an elongate lens 10 having excellent optical characteristics may be provided.

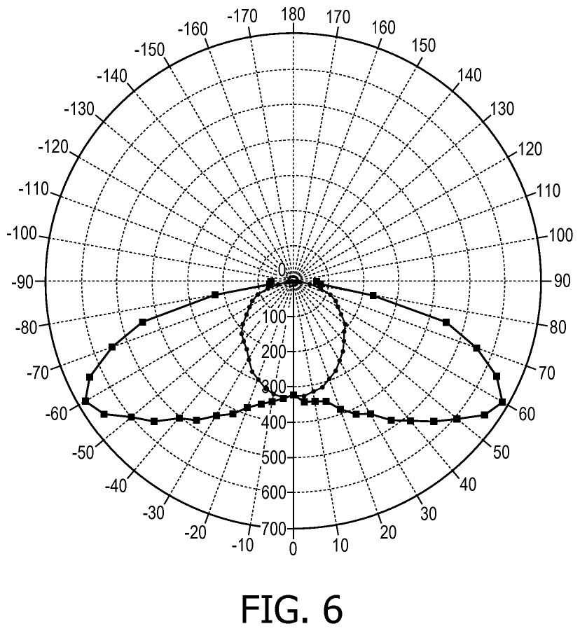

FIG. 6 is a polar plot of the luminous distribution produced by a lighting device 100 including the elongate lens 10 according to an embodiment of the present invention. Two luminous distributions can be recognised in this polar plot; a substantially circular distribution produced in the length or elongation direction of the elongate lens 10 and a winged distribution produced in the width direction of the elongate lens 10.

The lighting device 100 including the elongate lens 10 may be a stand-alone lighting device 100 such as a light strip, light bulb or the like or may form part of a larger device. An example of such a larger device is a luminaire including the lighting device 100, in which the lighting device 100 may form an integral part of the luminaire or may be removably mounted in the luminaire in order to facilitate a replacement of the lighting device 100 at its end of life. For example, such a luminaire may be a ceiling luminaire such as a troffer or the like comprising one or more of the lighting devices 100, e.g. a plurality of lighting devices 100 arranged in a parallel orientation. Another example of such a luminaire may be a desk lamp or the like having an elongate lamp holder for illuminating a desk surface. Other examples of such a luminaire include a street lamp, a vehicle lamp such as a vehicle headlamp or taillight, and so on.

According to an aspect, the lighting device 100 may be integrated in an electronic device such as a household appliance, either by itself or as part of a luminaire according to embodiments of the present invention. Such a household appliance for example may be an extraction hood over a cooker, in which one or more lighting devices 100 are integrated to illuminate the cooker surface, a microwave oven comprising one or more lighting devices 100 to illuminate microwave compartment of the microwave oven, a fridge or freezer in which one or more lighting devices 100 are arranged to illuminate the interior compartment of the fridge or freezer, and so on. Other examples of suitable electronic devices will be immediately apparent to the skilled person.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A lens which is an integrated single piece, comprising an inner arch and an outer arch, the inner arch and outer arch having a shared elongate central region and each having opposing walls extending from opposite elongate ends of the shared elongate central region, wherein the walls of the inner arch are spatially separated from the walls of the outer arch, and the walls of inner arch extends such that a cavity is formed by the inner arch, wherein a light source can be positioned under the inner arch and within the cavity formed by the inner arch.

2. The lens of claim 1, wherein the lens is made of an optical grade polymer or a blend of optical grade polymers.

3. The lens of claim 2, wherein the optical grade polymer or blend of optical grade polymers is selected from one or more of polyethylene terephthalate, poly and polycarbonate.

4. The lens of claim 2, wherein the optical grade polymer is polycarbonate.

5. The lens of claim 1, wherein the respective walls of the inner arch and/or the respective walls of the outer arch have a thickness that varies by less than 20%.

6. The lens of claim 5, wherein the respective walls of the inner arch and/or the respective walls of the outer arch have a thickness that varies by less than 10%.

7. The lens of claim 5, wherein the respective walls of the inner arch and/or the respective walls of the outer arch have a thickness that increases in a direction away from the shared elongate central region.

8. The lens of claim 1, further comprising at least one intermediate arch in between the inner arch and the outer arch, the at least one intermediate arch including the shared elongate central region and having a pair of walls extending from opposite elongate ends of the shared central region, the walls of the at least one intermediate arch being spatially separated from and located in between the respective walls of the inner arch and outer arch.

9. The lens claim 1, wherein an outer surface of the outer arch is semi-cylindrical; the inner arc and the outer arch have a curved cross-sections and are both bent in a same direction.

10. A lighting device comprising a substrate carrying the lens of claim 1 such that at least two of the walls of the respective arches of the lens are placed on the substrate, the substrate further carrying at least one solid state lighting device positioned within a cavity delimited by the inner arch of the lens, the at least one solid state lighting device being arranged to direct its luminous output towards the inner arch.

11. The lighting device of claim 10, wherein the at least one solid state lighting device comprises a plurality of solid state lighting elements at regular intervals within the cavity.

12. The lighting device of claim 11, wherein the solid state lighting elements share a carrier, said carrier being mounted on the substrate.

13. The lighting device of claim 10, wherein the at least one solid state lighting device is a LED.

14. A luminaire comprising the lighting device of claim 1.

15. An apparatus comprising the lighting device of claim 1.
